(19) United States
(12) Patent Application Publication
(10) Pub. No.: US 2024/0416600 A1
(43) Pub. Date: Dec. 19, 2024

(54) METHODS AND DEVICES FOR MOULDING COMPOSITE MATERIALS

(71) Applicant: HEXCEL REINFORCEMENTS, Dagneux (FR)

(72) Inventors: Pascal PERRILLAT-COLLOMB, Saint-Victor-De-Morestel (FR); Jacques DUCARRE, Corbelin (FR); Thomas ZIMMER, Chambery (FR); Jean POURTIER, le Bourget du lac (FR)

(73) Assignee: HEXCEL REINFORCEMENTS, Dagneux (FR)

(21) Appl. No.: 18/259,998

(22) PCT Filed: Jan. 10, 2022
(86) PCT No.: PCT/FR2022/050050

§ 371 Date: Jun. 29, 2023

(30) Foreign Application Priority Data
Jan. 14, 2021 (FR) FR2100363

(51) Int. Cl. B29C 70/44; B29C 70/54

(52) U.S. Cl. CPC B29C 70/446; B29C 70/542

(57) ABSTRACT

The invention relates to a process for preforming a composite material (I) in the form of a plate comprising reinforcing fibers bonded together, in particular by a plastic polymer material. In particular, such a process comprises an intermediate forming phase (b) comprising at least the following operations:
introducing gas (III) into the second chamber (4), while maintaining the pressure P2 of the second chamber (4) below the external pressure Pext, and in particular atmospheric pressure, when the external pressure Pext is equal to atmospheric pressure, and thereby locally maintaining the upper diaphragm (2) at a distance from the lower diaphragm (1), and while maintaining, at the contact zone (5), both the alignment and the contact between the composite material (I) and the two diaphragms (1 and 2),
evacuating gas (III) contained in the first chamber (3), so as to press the lower diaphragm (1) over the entire forming surface (22) present at the bottom (21) of the mold (20).

The invention also relates to a device adapted to the implementation of such a process.

### TECHNICAL FIELD

This invention relates to the field of processes for forming composite materials and devices adapted to such processes.

### PRIOR ART

Composite materials are made up of a set of reinforcing fibers, notably carbon or aramid, combined with a polymer material that at least partially provides for the bonding of the reinforcing fibers together. Composite materials are often intended for the production of composite parts of more or less complex shapes, especially for the aeronautics, automotive, sports, or energy fields. The manufacture of composite parts or articles can be performed by two types of processes: the so-called “indirect” processes and the so-called “direct” or “LCM” (Liquid Composite Molding) processes.

An indirect process uses composite materials known as preimpregnated with a polymer resin which are shaped to produce the desired composite part, by means of a compression molding operation. The fibrous prepreg materials include the desired amount of resin for the final composite part.

A direct process is defined by the fact that one or more fibrous reinforcements are processed in the “dry” state (that is, without the final matrix), with the resin to be used as a matrix being processed separately, for example, by injection into the mold containing the fibrous reinforcements (the “RTM” (Resin Transfer Molding) process), by infusion through the thickness of the fibrous reinforcements (“LRI” (Liquid Resin Infusion) process or “RFI” (Resin Film Infusion) process), or by manual coating/impregnation by roller or brush, on each of the individual layers of fibrous reinforcements, applied successively on the form.

For RTM, LRI, or RFI processes, a pre-form in the shape of the desired finished article must generally be manufactured first, then this preform, usually a stack of plies, is impregnated with a resin intended to constitute the matrix. The resin is injected or infused by means of pressure and temperature differentials, then after the entire amount of resin required is contained in the preform, the assembly is heated to a higher temperature to complete the polymerization/cross-linking cycle and thereby cause it to harden.

The starting composite materials, whether dry or prepreg, have a flat surface and are provided in the form of flat structures, also known as plates, which must be shaped into the desired shape of the final composite part. Often, the shaped composite material consists of a stack of several plies of material that have previously been combined to form a single plate, which is also known as a preform. The forming processes in the prior art are mainly of two types:
processes that use an open mold with a non-planar forming surface at the bottom, in combination with a diaphragm to close the mold, as illustrated in FIG. 1, which will be referred to as single diaphragm processes, and
processes that use an open mold in combination with two diaphragms between which the composite material to be shaped is placed, as illustrated in FIG. 2, which will be referred to as dual-diaphragm processes.

Single-diaphragm processes are suitable for forming convex, single-curved parts. These processes allow many possibilities of deformation, especially bending and inter-ply sliding. However, one of their major disadvantages is linked to the imbalance of the flat composite material to be preformed, which is simply placed on the convex shape intended to give it its shape during the first step of the process, as illustrated in FIG. 1. Moreover, the alignment of the diaphragm on this composite material can also have an impact on its positioning on the bottom in the shape of the mold. Thus, the positioning of the starting material and, consequently, its deformation are not controlled, which reduces the mechanical performance of the resulting preform. Moreover, in such a process, there is a lack of control of the material remaining to be formed during the forming process, and difficulties in obtaining shapes with dual curvature. Finally, in the single-diaphragm process, there are no parameters that can be adjusted during the process, which could be a potential source of optimization of the process, for a given starting composite material and geometry.

In order to overcome positioning problems, so-called dual-diaphragm processes have been developed. Such forming processes, under reduced pressure using two diaphragms, have the advantage of ensuring that the composite material is held and precisely positioned during the entire forming process. They also offer the possibility of forming the composite material in dual-curvature geometries by means of plane shear deformation under transverse stresses.

To this end, the composite material is placed between two diaphragms and reduced pressure is created between the two diaphragms to ensure that the composite material is held in place prior to forming. Dual-diaphragm processes offer:
a control of the position of the plies, since after the planar material is positioned on lower diaphragm 1 as illustrated in FIG. 2, it is not subject to gravity displacement, as in the single-diaphragm process,
an improved ability to implement automation,
a possibility to modulate the process, by varying the pressure applied between the two diaphragms, as proposed in U.S. Pat. No. 9,259,859,
possibilities for use in forming materials with more complex geometries than in the single-diaphragm process, especially in the case of asymmetrical configuration. Indeed, bending deformations are always predominant, but the modes of deformation extend to intra- and inter-ply sliding, as well as to plane shearing, which makes it possible to obtain dual-curved shapes.

However, it has been found that transverse stresses limit inter-ply sliding, which could induce defects (for example, creases) on the resulting shaped materials, even in the case of simple curvature. Indeed, the application of a near-vacuum pressure between the two diaphragms increases the compaction of the composite material and reduces the sliding capacity of the fibers and, when the composite material is in the form of a stack of several plies, the sliding capacity between the plies, which leads to the appearance of creases during shaping. In order to reduce this phenomenon, U.S. Pat. No. 9,259,859 proposed to vary the pressure applied in the inter-diaphragm space during the first phase of the process, holding it at a higher value (500 mbar in the examples), before reducing it to a value below 10 mbar during the final forming and compaction operation. However, such a modulation does not completely eliminate defects, although a reduction can be seen. Depending on the materials, their thicknesses and the desired geometries, defects may persist.

In this context, the invention proposes new forming processes and devices that make it possible to resolve the forming problems encountered in the prior art. The inventors have developed processes and devices that offer greater flexibility and thus make it possible to benefit from the advantages of both the single- and dual-diaphragm processes, while at the same time compensating for their disadvantages.

### Disclosures of the Invention

The present invention relates to a process for preforming a composite material in the form of a plate comprising reinforcing fibers bonded together, in particular by a plastic polymer material, in which the composite material to be preformed is placed within a forming device, comprising a first sealed chamber formed between a mold having a forming surface and a lower diaphragm, said first chamber defining a first modular volume V1 and a second sealed chamber formed between the first diaphragm and a second diaphragm placed above the first diaphragm, said second chamber defining a second modular volume V2, referred to as the inter-diaphragm volume, the composite material being housed in this inter-diaphragm volume V2. The process according to the invention comprises an intermediate forming phase (b) during which gas is introduced into the second chamber, and the upper diaphragm is thereby maintained locally at a distance from the lower diaphragm, while maintaining the pressure P2 of the second chamber below the external pressure Pext at the forming device, and in particular atmospheric pressure, when the external pressure Pext is equal to atmospheric pressure, and, placing the lower diaphragm in abutment on the forming surface.

The purpose of the invention is a process for preforming a composite material in the form of a plate, said composite material comprising reinforcing fibers bonded together, in particular by a plastic polymer material, said process comprising the following successive phases:
(a) a positioning phase of the composite material within a forming device comprising the following operations:
(a1) providing a mold with a non-planar bottom that defines a forming surface corresponding to the shape to be given to the composite material to be preformed,
(a2) placing, above the bottom of the mold, a first diaphragm, referred to as the lower diaphragm, on which the composite material to be preformed is deposited, and a second diaphragm extending above the composite material, referred to as the upper diaphragm, said two diaphragms being elastically deformable and impermeable to gas, and said composite material being placed above the forming surface,
(a3) positioning the two diaphragms together with the mold so as to form:
a first sealed chamber between the mold and the lower diaphragm, said first chamber defining a first modular volume V1, and
a second sealed chamber between the two diaphragms, said second chamber defining a second modular volume V2, referred to as the inter-diaphragm volume, the composite material being housed in this inter-diaphragm volume V2,
(a4) evacuating gas from the second chamber and thereby reducing the inter-diaphragm volume V2, so that both diaphragms are in contact with the composite material,
(a5) locally attach the lower diaphragm to the forming surface in at least one contact zone, the composite material and the two diaphragms also being in contact at said contact zone,
the positioning phase resulting in the placement of the composite material within the forming device thus obtained, said forming device itself being placed under an external pressure Pext, which may be equal to atmospheric pressure, the placement of the composite material within the forming device corresponding to the composite material being held by the two diaphragms both in contact with it, with a local alignment of the lower diaphragm on the forming surface, in at least one contact zone,
(b) an intermediate forming phase comprising at least the following operations:
introducing gas into the second chamber, while maintaining the pressure P2 below the external pressure Pext, and in particular atmospheric pressure, when the external pressure Pext is equal to atmospheric pressure, and thereby maintaining the upper diaphragm locally at a distance from the lower diaphragm, while maintaining, at the contact zone, both the alignment and the contact between the composite material and the two diaphragms,
evacuating gas from the first chamber so as to press the lower diaphragm over the entire forming surface at the bottom of the mold,
(c) a final forming and compaction phase resulting in the desired final shape of the preformed composite material, during which heating is applied, during which the gas contained in the second chamber is removed, so as to press both the composite material and the upper diaphragm onto the lower diaphragm, which is itself pressed onto the bottom of the mold, in particular onto the forming surface, and to obtain a reduction in pressure P2, so as to ensure compaction,
(d) a cooling phase and a unmolding phase of the preformed composite material.

The process according to the invention is therefore a hybrid process using two diaphragms to form composite materials under reduced pressure. It makes possible hybridization of the two processes of single- and dual-diaphragm forming of the prior art: at the beginning, the placement and the maintenance of the composite material plane are ensured by means of the presence of the two diaphragms and, this control is continued throughout the process, because throughout the process, the two diaphragms are maintained in contact with the composite material, at least at the level of the contact zone, where the diaphragm/composite material assembly is supported on the forming surface. At the end of the positioning phase (a), the composite material is kept compressed between the two diaphragms, the second inter-diaphragm chamber being advantageously at its minimum volume, following operation (a4), and the lower diaphragm abutting on the forming surface, on at least one contact zone, corresponding in particular to the highest zone of the forming surface. Subsequently, the mechanical stresses applied to the composite material during intermediate forming (b) are varied by adjusting the volume of the second chamber between the two diaphragms in which the composite material is positioned, thereby reducing the mechanical stresses to which the composite material is subjected during forming. In the intermediate forming step (b), the invention provides for reducing the pressure that the two diaphragms exert on the composite material, thereby reducing/eliminating the risk of wrinkling, and, in particular, wrinkling resulting from uncontrolled inter-ply sliding due to flexural deformation. The process according to the invention provides for an intermediate forming step (b) (also called preforming step) during which the composite material regains a freedom of movement that ensures an optimal (flawless) quality. However, its correct positioning is ensured by the pressure exerted by the upper diaphragm and the support on the forming surface at the contact zone.

In particular, in the intermediate forming phase (b), a gaseous medium is introduced into the second chamber, leading to an increase in the volume of said second chamber, while at the same time maintaining the pressure P2 below the external pressure Pext, and in particular the atmospheric pressure, when the external pressure Pext is equal to atmospheric pressure. Thus, the upper diaphragm is held locally at a distance from the lower diaphragm, while maintaining, at the contact zone, both alignment and contact between the composite material and the two diaphragms. This spacing of the upper membrane from the lower membrane over part of its surface is achieved by the presence of the gaseous medium added to the second chamber during the intermediate forming phase (b). In particular, the upper membrane is also locally spaced from the composite material (while maintaining both alignment and contact between the composite material and the two membranes at the contact zone).

According to the invention, the approach and positioning of the reinforcing material on the forming surface is controlled. The reinforcing material will follow the movement of the first diaphragm as it descends and is more or less completely and rapidly pressed on the forming surface. On the other hand, by increasing the volume of the second chamber during intermediate forming (b), while maintaining the pressure P2 below the external pressure Pext, and in particular atmospheric pressure, when the external pressure Pext is equal to atmospheric pressure, the descent of the upper diaphragm does not follow the reinforcing material and the lower diaphragm, and its movement has an displacement with the lower diaphragm, except over a more or less large area at the contact zone corresponding to the initial alignment. The space maintained between the two diaphragms, during this intermediate forming phase (b), gives more freedom of movement to the fibers within the material and will minimize stresses and avoid the presence of defects in the final formed material. However, the support maintained at the contact area of the upper diaphragm on the composite material, itself resting on the lower diaphragm, itself resting on the forming surface, makes it possible to position the composite material to be secured and prevents it from sliding on the forming surface and ensures that the correct shape is obtained.

In addition, the process according to the invention increases the number of parameters that can be modified during its implementation, thus making it possible to modulate the shaping according to the material and the desired final geometry, in particular. It is also ideally suited for automation.

In the process according to the invention, operation (a5) is performed after operation (a4) by evacuating the gas in the first chamber, resulting in a reduction in the volume V1 of the first chamber, so as to establish a pre-contact between the lower diaphragm and the forming surface, while the volume V2 of the second chamber is held constant.

According to another embodiment that can be combined with the previous one, throughout the intermediate forming phase (b), the introduction(s) and withdrawal(s) of gas are performed in such a way that the pressure P1 in the first chamber and the pressure P2 in the second chamber are controlled and/or modified, so that the pressure P1 remains lower than the pressure P2, which is itself lower than the external pressure Pext, and in particular lower than atmospheric pressure when the external pressure Pext is equal to atmospheric pressure.

According to the invention, throughout the intermediate forming phase (b), heating of the composite material can be provided, so as to obtain softening of the plastic polymer material. The use of such heating, which may act as an aid to preforming, will be adapted by a person skilled in the art, according to the nature of the constituent polymer or polymers of the plastic polymer material. Typically, a heating at a temperature in the range of 40° C. to 250° C., in particular between 70° C. and 200° C., can be provided. However, the process according to the invention is also perfectly adapted to perform so-called cold preforming (room temperature, of the order of 25° C.), depending on the polymer plastic material present in the composite material. Classically, as in the processes of the prior art, the final stage of forming and compaction is performed hot, in particular, at a temperature in the range of 40 to 250° C., in particular between 70° C. and 200° C., depending on the polymer plastic present in the composite material.

When heating is applied at any stage of the process, the temperature rise changes the mechanical properties of the material, the gas volume and the pressure. By varying the inter-diaphragm volume and/or the volume of the first chamber, it is thus possible to better adapt the volume of the first chamber to these modifications.

According to particular embodiments, the process according to the invention includes a temperature rise step, so that throughout the intermediate forming phase, a heating of the composite material is ensured, in order to obtain softening of the plastic polymer material and in that, during the step of temperature rise resulting in the desired heating temperature, the volumes V1 and V2 of the first and second chamber are controlled to avoid increased volumes.

According to a first alternate embodiment of the processes according to the invention, the intermediate forming stage (b) is performed by removing the gas contained in the first chamber by suction, so as to press the lower diaphragm over the entire forming surface present at the bottom of the mold, while introducing gas into the second chamber and maintaining the pressure P2 in the second chamber below the external pressure Pext, and in particular the atmospheric pressure, when the external pressure Pext is equal to the atmospheric pressure and, thus, increase the inter-diaphragm volume V2, and locally maintaining a distance between the upper diaphragm and the lower one, while maintaining, at the contact zone, both the alignment and the contact between the composite material and the two diaphragms. Advantageously, the decrease in the volume V1 of the first chamber is equal or substantially equal to the increase in the volume V2 of the second chamber. According to the invention, substantially equal means equal to plus or minus 5% or even plus or minus 2%.

According to the second alternate embodiment of the processes according to the invention, the intermediate forming phase (b) comprises the following successive operations:

(b1) evacuation of the gas contained in the first chamber, resulting in the reduction in the volume V1, so as to cause the lower diaphragm to descend to an intermediate position, while introducing gas into the second chamber and maintaining the pressure P2 in the second chamber below the external pressure Pext, and in particular atmospheric pressure, when the external pressure Pext is equal to atmospheric pressure and, thus, increase the inter-diaphragm volume V2, and locally maintaining the upper diaphragm at a distance from the lower diaphragm, while maintaining, at the contact zone, both the alignment and the contact between the composite material and the two diaphragms, (b2) evacuation of gas from the first chamber so as to press the lower diaphragm against the entire forming surface at the bottom of the mold, while holding the inter-diaphragm volume V2 constant.

In particular, step (b2) involves a delayed but synchronous plating of the second diaphragm onto the composite material to be formed, the first diaphragm and the forming surface, followed by step (c).

Advantageously, in the second alternate embodiment of the processes according to the invention also, in step (b1), the decrease of the volume V1 of the first chamber is equal or substantially equal to the increase of the volume V2 of the second chamber.

According to a third alternate embodiment of the processes according to the invention, the intermediate forming phase (b) comprises the following successive operations:
(b′1) evacuation of the gas contained in the first chamber, resulting in a reduction of the first volume V1, so as to cause the lower diaphragm to descend to an intermediate position, while introducing gas into the second chamber and maintaining the pressure P2 in the second chamber below the external pressure Pext, and in particular atmospheric pressure, when the external pressure Pext is equal to atmospheric pressure and, thus, increase the inter-diaphragm volume V2, and locally maintaining the upper diaphragm at a distance from the lower diaphragm, while maintaining, at the contact zone, both the alignment and the contact between the composite material and the two diaphragms,
(b′2) evacuation of the gas from the second chamber and thereby reduce the inter-diaphragm volume V2, so as to cause the upper diaphragm to descend and place both diaphragms in contact with the composite material,
(b′3) evacuation of the gas contained in the first chamber, so as to press the lower diaphragm over the entire forming surface present at the bottom of the mold, while introducing gas into the second chamber and maintaining the pressure P2 in the second chamber below the external pressure Pext, and in particular atmospheric pressure, when the external pressure Pext is equal to atmospheric pressure and, thus, increase the inter-diaphragm volume V2, and locally maintaining the upper diaphragm at a distance from the lower diaphragm, while maintaining, at the contact zone, both the alignment and the contact between the composite material and the two diaphragms.

Advantageously, in this third alternate embodiment of the processes according to the invention also, in operation (b′1) and/or operation (b′3), the decrease in the volume V1 of the first chamber is equal or substantially equal to the increase of the volume V2 of the second chamber.

In the third alternate embodiment of performing the processes according to the invention, operations (b′1) to (b′2) may, in particular, be repeated, for example one to ten times, so as to gradually cause the descent of the lower diaphragm and the upper diaphragm.

In the processes according to the invention, irrespective of the embodiment or alternate embodiment, in general, in step (a2) and step (a3), the two diaphragms are arranged horizontally. This allows for better control of the positioning of the plate-like composite material, resting on the lower diaphragm, at the beginning of the process. The horizontal position is maintained during step (a3), which simply consists of forming chambers and thus of obtaining a seal between the diaphragms on the one hand and the lower diaphragm and the mold on the other hand, as will become understood from the explanations that follow in the description.

In the processes according to the invention, irrespective of the embodiment or alternate embodiment, in general, at the end of step (a2), the two diaphragms are flat, or stretched so as to minimize their flexural deformation (out-of-plane) induced by their own weight. However, the diaphragms are stretched, avoiding a flat elongation (that is, in the plane of said diaphragm) too important, in order to preserve their capacity of elastic deformation, or even plastic deformation. For this purpose, each diaphragm is stretched, but preferably its plane elongation is less than 5%.

According to one embodiment, compatible with all the embodiments and alternate embodiments of the processes according to the invention, during the cooling phase, the pressure in the first chamber can be increased, in particular to reduce friction with the mold. Then, the pressure P2 in the second chamber will be lower than the pressure P1 in the first chamber, which is itself lower than or equal to the external pressure Pext, and in particular atmospheric pressure, when the external pressure Pext is equal to atmospheric pressure (1.013 bar). In particular, a pressure P1 in the range from 850 mbar to atmospheric pressure (1.013 bar) can be obtained in the first chamber, during the cooling phase, when the external pressure Pext is equal to atmospheric pressure. This increase in pressure can be achieved by adding gas to the first chamber, in particular by adding air. However, both diaphragms will remain pressed on the composite material and on the forming surface, and therefore the volumes V1 and V2 will be held constant.

The processes according to the invention are suitable for forming so-called dry composite materials, intended for the direct manufacturing processes of composite parts. In particular, the plastic polymer material represents at most 10% of the total weight of the composite material, preferably from 0.5 to 10% of the total weight of the composite material in the form of a plate, and preferably from 2% to 6% of the total weight of the composite material. The processes according to the invention may also be used for forming prepreg composite materials which include a larger plastic content of more than 10%. In particular, the plastic polymer material may, in this case, represent at least 20% of the total weight of the composite material in the form of a plate and up to 60% of the total weight of the composite material in the form of a plate, and preferably from 20% to 40% of the total weight of the composite material in the form of a plate.

Irrespective of the composite material present in the form of a plate, the plastic polymer material is, in particular, selected from thermoplastic polymers, thermosetting polymers, polymers comprising a thermoplastic part and a thermosetting or cross-linked part, and admixtures thereof.

In addition, conventionally, the composite material is formed of glass, carbon, aramid or ceramic fibers, or of any other reinforcing fibers known to a person skilled in the art, carbon fibers and glass fibers being particularly preferred.

According to certain embodiments, as it is notably the case in the examples, the composite material in the form of a plate comprises a stack of fibrous reinforcing layers, said fibrous reinforcing layers being notably selected from fabrics and unidirectional layers of reinforcing fibers. This stack of fibrous reinforcing layers has a uniform character, obtained by the polymer plastic material and/or by any other means, of the sewing or knitting type.

The invention also relates to a device for preforming a composite material in the form of a plate, comprising:
a mold having a non-planar bottom that defines a forming surface for a composite material to be preformed,
a first diaphragm, referred to as the lower diaphragm, a second diaphragm, referred to as the upper diaphragm, said two diaphragms being elastically deformable and impermeable to gas, and being placed one above the other and extending above the bottom of the mold,
a positioning device that makes it possible to form with the two diaphragms and the mold:
   a first sealed chamber between the mold and the lower diaphragm, said first chamber defining a first variable volume V1, and
   a second sealed chamber between the two diaphragms, said second chamber defining a second variable volume V2, referred to as the inter-diaphragm volume, which is intended to receive the composite material to be preformed,
   the first and the second chambers each being equipped with an outlet valve, making it possible to ensure the exit of the gaseous medium contained in said chamber, said outlet valves each being connected to a circuit equipped with a gaseous medium flow and pressure regulator making possible for the gaseous medium to be evacuated from the chamber concerned, characterized in that the second chamber is equipped with an inlet valve, making it possible to ensure the entry of a gaseous medium into the second chamber, said inlet valve being connected to a circuit equipped with a gaseous medium flow and pressure regulator, making it possible to ensure the introduction of a gaseous medium into the second chamber.

According to a preferred embodiment, the first chamber is equipped with an inlet valve, allowing the entry of a gaseous medium into the first chamber, said inlet valve being connected to a circuit equipped with a gaseous medium flow and pressure regulator, allowing the introduction of a gaseous medium into the first chamber. Such a device makes it possible, in particular, to increase the pressure in the first chamber, especially to reduce friction with the mold during the cooling phase.

In the forming devices proposed in the prior art, the outlet valves exist only at the level of the two chambers and have the function of removing air from the inter-diaphragm space and from the space between the lower diaphragm and the mold. Therefore, the pressures and volumes in both chambers can be reduced only during shaping. According to the invention, an inlet valve has been added at the level of the second chamber (inter-diaphragm chamber), or even at the level of the first chamber (chamber located between the lower diaphragm and the mold), thereby making it possible to increase the volume and/or the pressure in the chamber concerned, thereby modulating the process and reducing the stresses imposed on the material during the intermediate stage of forming, or even during cooling.

In any of the devices according to the invention, some or all of the inlet and outlet valves may correspond to various valves or taps. It is also possible that the inlet and outlet valves fitted to the same chamber may, in fact, be a single valve comprising an inlet and an outlet which is connected to a pneumatic system to modulate the valve in the inlet mode or in the outlet mode in the direction of the chamber/external circuit.

In some embodiments, it can be foreseen that the device includes an external circuit for the circulation of gas from the first chamber to the second chamber. Such a configuration facilitates the simultaneous modification of the volumes of both chambers.

### BRIEF DESCRIPTION OF THE DRAWINGS

FIG. 1 is a cross-sectional diagram of a device used in the prior art, in forming processes using a single diaphragm (the so-called single-diaphragm process).

FIG. 2 is a cross-sectional diagram of a device used in the prior art, in forming processes using two superimposed diaphragms (dual-diaphragm process).

FIG. 3A is a cross-sectional diagram of a device according to the invention, adapted to the implementation of forming processes according to the invention.

FIG. 3B is cross-sectional diagram of another device according to the invention, suitable for carrying out forming processes according to the invention, in which the first chamber is equipped with a valve for the gas inlet.

FIG. 4 is a perspective view of a forming device according to the invention, illustrating a connecting device for forming the two chambers and holding the two diaphragms on the mold.

FIG. 5 is a partial perspective view illustrating the various parts of the connecting device illustrated in FIG. 4.

FIG. 6 is a diagram of the various steps of a process according to the invention, in accordance with the first alternate embodiment.

FIG. 7 is a diagram of various steps of a process according to the invention, in accordance with the second alternate embodiment.

FIG. 8 is a diagram of various steps of a process according to the invention, in accordance with the third alternate embodiment.

FIG. 9 is a cross-sectional diagram of a device according to the invention, comprising an external circuit for the circulation of gas from the first chamber to the second chamber.

FIG. 10 is a perspective view of the protrusion present at the forming area of the mold used in examples 1a to 3.

FIG. 11 illustrates the preformed material obtained in comparative example 1b and illustrates the presence of creases constituting defects.

### DESCRIPTION OF THE EMBODIMENTS

Before describing the various embodiments of the invention, some concepts and terms will be defined.

A composite material, present in the form of a plate, can be composed of a reinforcing fiber and plastic polymer material-based single material, or correspond to a stack of such materials. The composite starting material is planar, and is referred to as a plate to reflect the fact that its width and length are much greater than its thickness, although it can have a certain thickness. In particular, a material in the form of a plate can have a width and length, each being at least 10 times or even at least 10 to 1000 times the thickness of the starting composite material. Within the scope of this invention, composite starting materials in the form of a plate have, in particular, a thickness of 0.2 mm to 50 mm, preferably 0.5 mm to 20 mm.

Any composite starting material used in forming operations in the prior art may be used within the scope of the invention. Such materials comprise one or more fibrous reinforcing layers, in particular one or more layers of reinforcing fibers selected from glass, carbon, aramid, or ceramic fibers, carbon fibers and glass fibers being particularly preferred.

Such a composite material in the form of a plate may be formed by an assembly of reinforcing fibers bonded together by a plastic polymer material or by a stack of fibrous reinforcing layers comprising a plastic polymer material, said layers being bonded together by the plastic polymer material and/or by any other suitable means, in particular by sewing or by knitting.

In particular, the fibrous composite material comprises a fibrous reinforcement layer or a stack of fibrous reinforcement layers, and in particular is selected from:
unidirectional sheets having structural support provided by a polymer binder, by sewing, or by knitting;
assemblies of superimposed unidirectional layers having various orientations, constituting multiaxial reinforcements, commonly referred to as Non-Crimp Fabrics (NCF), held together by sewing or knitting;
fabrics (or woven fabrics) having structures of interlaced threads or strands following the insertion of threads, known as weft threads, between the threads they cross, known as warp threads, having in particular a taffeta, a twill, or a satin reinforcement, or those of the interlaced type, as described by C. Dufour, F. Boussu, P. Wang, D. Soulat and X. Legrand: “Analyse du comportement de renforts tissés interlock lors du procédé de préformage [Analysis of the behavior of interlock woven reinforcements during the preforming process]” in the 21st Congrès Français de Mécanique [French Congress of Mechanics], 2013, pages 5-6;
braids having a structure with interlaced threads or rovings, in which the interlocking is not the result of an insertion process. Such braids may, in particular, be of the bi-axial, tri-axial or interlock type. See in particular the thesis of Boris Duchamp (https://www.theses.fr/197146112) Contribution à l′élaboration de préformes textiles pour le renforcement de réservoirs souples [Contribution to the development of textile preforms for the reinforcement of flexible cavities under the direction of Damien Soulat and Xavier Legrand-Lille 1, 2016 and M. Kowalski, “Développement de croisements de raidisseurs composites [Development of composite stiffener crossings]: Technology, Modelling and Optimization”, Thesis, University of Lille 1, 2015, and T. Liao and S. Adanur, “A novel approach to Three-dimensional modeling of interlaced fabric structures”, Text. Res. J., Vol. 68, pages 841-847, 1998;
knits, obtained by loops interlaced with each other. Such knits may, in particular, be of the gathered stitch (or weft knit), cast off stitch (or warp knit) or interlock type. Interlock knits are a variation of the other two structures with interlacing loops in the thickness, either between various layers of loops or by creating an ordered structure based on repeatable and repeated three-dimensional patterns.

In particular, composite material I comprises a stack of fibrous reinforcement layers, as previously defined, and at least one porous layer of a plastic polymer material. Such a porous polymer layer may in particular be in the form of a porous film, a grid, a powder coating, a fabric or, preferably, a non-woven or a veil.

In particular, the composite material may consist of a fibrous reinforcing layer with a porous layer of a plastic polymer on each of its faces, or of a stack of several fibrous reinforcing layers, between which one or more porous layers of a plastic polymer are interposed. Providing a uniform character to the composite material is ensured by the association of the layers among themselves before it is placed in the device according to the invention, thereby ensuring its shape. The prior bonding of the fibers, or even of the layers, to each other, can either be obtained solely by the hot adhesive character of the plastic polymer material present, or can be obtained or completed by the use of other types of bonding such as sewing or knitting.

Examples of composite materials include:
composite materials consisting of a unidirectional sheet of reinforcing fibers associated on each of its faces with one or more porous layer(s) of a plastic polymer, and in particular a non-woven, and stacks thereof,
assemblies of several unidirectional sheets of reinforcing fibers oriented in at least two different directions, with one or more porous layer(s) of a plastic polymer material present between the unidirectional sheets and on the surface, said assembly being bonded by sewing or knitting.

These may be dry materials (that is, the plastic polymer material represents at most 10% of the total weight of the composite material, preferably 0.5%-10% of the total weight of the composite material, and preferably 2%-6% of the total weight of the composite material in the form of a plate) or prepregs.

Such materials are described in particular in patent applications or patents EP 1125728, U.S. Pat. No. 6,828,016, WO 00/58083, WO 2007/015706, WO 2006/121961, U.S. Pat. No. 6,503,856, US 2008/7435693, WO 2010/046609, WO 2010/061114 and EP 2 547 816, US 2008/0289743, US 2007/8361262, US 2011/9371604, WO 2011/048340, EP 2547816, WO 2010/067003, U.S. Pat. Nos. 8,361,262, 9,371,604, WO 2011/113751 and EP 2491175, or in U.S. Pat. No. 9,259,859.

Plastic polymer material” means any polymer or mixture of polymers that is capable of being deformed, with or without the application of heat. Thus, the composite material in the form of a plate containing such a plastic polymer material can be deformed and molded to the desired shape by applying the process according to the invention. It can thus be a thermoplastic, thermosetting polymer, a polymer comprising a thermoplastic part and a thermosetting or cross-linked part or a mixture of such polymers. Any plastic polymer material conventionally used for the manufacture of composite materials, intended for producing composite parts is suitable. Examples of thermosetting polymers are epoxy, phenolic, bismaleimide, cyanate resins, and admixtures of such resins. Examples of suitable thermoplastic polymers include: polyamides (PA: PA6, PA12, PA11, PA6,6, PA6, 10, PA6, 12, and the like.), polyamides (PA: PA6, PA12, PA11, PA6,6, PA6,10, PA6,12, . . . ), copolyamides (CoPA), polyamides-ether or ester block (PEBAX, PEBA), polyphthalamides (PPA), polyesters (Polyethylene terephthalate-PET-, Polybutylene terephthalate-PBT . . . ), copolyesters (CoPE), thermoplastic polyurethanes (TPU), polyacetals (POM . . . ), polyolefins (PP, HDPE, LDPE, LLDPE . . . ), polyethersulfones (PES), polysulfones (PSU . . . ), polyphenylene sulfones (PPSU . . . ), polyolefins (PP, HDPE, LDPE, LLDPE).), polyetheretherketones (PEEK), polyetherketone ketones (PEKK), polyphenylene sulfide (PPS), polyetherimides (PEI), thermoplastic polyimides, liquid crystal polymers (LCP), phenoxys, block copolymers such as styrene-butadiene-methylmethacrylate (SBM) copolymers, methylmethacrylate-butylmethacrylate (MAM) copolymers and admixtures thereof. It is also possible for the composite material to be in the form of a plate containing, as plastic polymer material, a partially cross-linked or partially cross-linkable thermoplastic polymer, as described in application WO 2019/102136. According to some embodiments, the plastic polymer material of the composite material in the form of a plate consists of a thermoplastic polymer or a polymer comprising a thermoplastic part or an admixture of such polymers.

“Diaphragm” means a thin and flexible partition, or in other words a flexible film. Conventional forming processes using an open mold, closed by the use of one diaphragm (single-diaphragm process) or two superimposed diaphragms (dual-diaphragm process), said diaphragm or diaphragms are capable of undergoing elastic deformation. The fact that a diaphragm can undergo elastic deformation is not exclusive, it does not exclude the fact that there is also plastic deformation. In the case of reusable diaphragms, the deformations are exclusively elastic. In the case of disposable, single-use diaphragms, the deformations can be elastic-plastic (one part elastic, one part plastic). Thus, such a diaphragm is not necessarily made of an elastomeric material, but may be made of an elastomeric material, as described in U.S. Pat. No. 9,259,859, filed behalf of Cytec. Diaphragms can be made in particular of rubber, nylon, or silicone. Some examples of diaphragms that can be used in the processes and devices of the invention are listed in Table 1.

TABLE 1

| | IPPLON | | | | | |
|---|---|---|---|---|---|---|
| | DP | Securlon | Stretchlon | Stretchlon | Diasil | |
| Reference | 1000 | L-1000 | 700 | 800 | 45 | 1453D |
| Supplier | Airtech | Airtech | Airtech | Airtech | Diatex | Solvay |
| Material | Nylon | Nylon | Thermoplastic | Nylon | HTV | Silicon |
| | | | Elastomer | | Silicon | |
| Elongation | 450% | 500% | 500% | 450% | >430% | 650% |
| at break | | | | | | |
| Tensile | 48 MPa | 82 MPa | 45 MPa | 69 MPa | >6 MPa | 4.2 MPa |
| strength | | | | | | |

The percentage elongation at break and tensile strength are measured as specified in ASTM D882.

In general, diaphragms with a thickness of 10 μm to 3000 μm, typically 50 μm to 100 μm, should be used.

The diaphragms used within the scope of the invention are described as impermeable to gas because they provide a barrier to gas. In other words, they are non-porous and do not allow the passage of gas through their thickness, which makes it possible to obtain a sealed chamber.

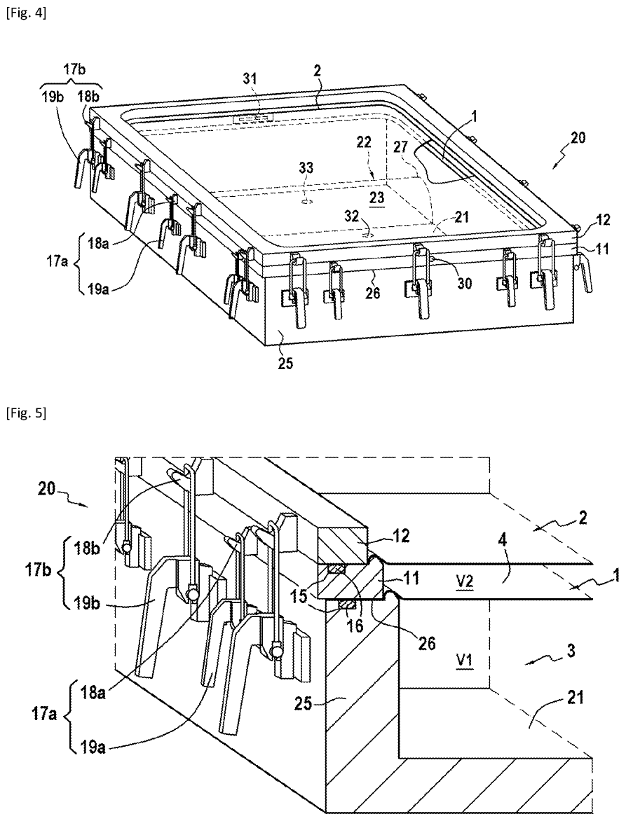

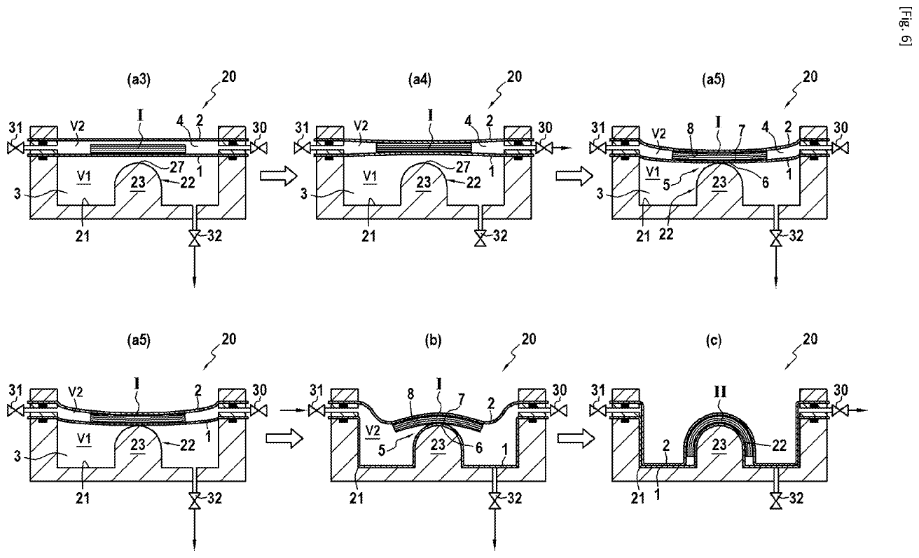

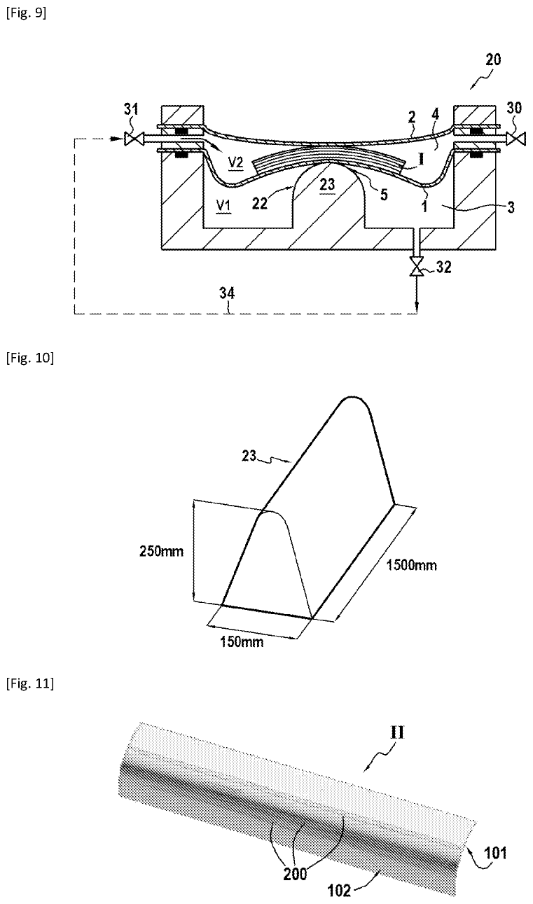

Devices according to the invention are illustrated in FIGS. 3A, 3B and 9. FIGS. 4 and 5 illustrate an example of such devices in greater detail.

FIG. 3A illustrates a device according to the invention, after the starting composite material I has been put into place and the two diaphragms 1 and 2 are positioned on mold 20 to form two sealed chambers 3 and 4. Mold 20 defines a tank or cavity and has at its bottom 21 a shaped surface which will constitute the forming surface 22 for composite material I. The forming surface 22 is non-planar and three-dimensional in shape, as opposed to the initial composite material I, which is planar and often described as two-dimensional by a person skilled in the art, although it has a certain thickness. In the example illustrated, this forming surface 22 corresponds to a convex-shaped protrusion 23 that extends into the middle of the bottom 21 of mold 20. In the example illustrated, the mold is square in shape and this protrusion 23 is symmetrical and has an axis parallel to two of the opposite peripheral walls 25 of the mold, as illustrated in FIG. 4. A perspective view of such a protrusion 23, but with a tapered cross-section, is illustrated in FIG. 10. It is also possible to provide other shapes for the forming surface 22, such as shapes that give the composite material a U, C, L, or V shape after it has been formed. Other more complex shapes with several embossings can also be provided as a forming surface 22.

The cavity defined by mold 20 is closed by a first diaphragm 1 which extends above the mold and is affixed to the peripheral edge 26 of the mold, as shown in FIG. 5 which is a partial perspective view of a device according to the invention. An arranging device makes it possible to create a sealed chamber between the first diaphragm 1 and the mold 20, referred to as the first chamber 3. The seal is provided by any suitable means. In the example shown in FIGS. 4 and 5, a gasket 16 is provided between the peripheral edge 26 of the mold and diaphragm 1 and a frame 11 is positioned on diaphragm 1 so as to rest on the peripheral edge 26 of the mold and clamp the lower diaphragm 1. In the example illustrated, clamping hook systems 17a, comprising a hook 18a on frame 11 and a fastener 19a on the external face of the peripheral wall 25 of mold 20, are used to clamp and fasten diaphragm 1 to mold 20. In the example shown, a groove 15 is provided on the peripheral edge 26 of the mold to allow the insertion of the gasket 16. In the example shown, a stop is also provided along the peripheral edge 26 of the mold to facilitate the positioning and alignment of the frame 11. Thus, the thickness of frame 11 will define the space between the two diaphragms and can be adjusted, depending on the thickness of the composite material I to be shaped.

The first diaphragm 1 extends horizontally and makes it possible to support and hold in position the composite material I that will be deposited on the upper surface 1a of this first diaphragm 1.

A second diaphragm 2 extends above the first diaphragm 1, the composite material I being located between these two diaphragms. The first diaphragm 1 is therefore referred to as the lower diaphragm and the second diaphragm 2 is referred to as the upper diaphragm. In the example illustrated, the upper diaphragm 2 extends parallel to the lower diaphragm 1, although an extension displaced from the horizontal plane can be expected, especially for the upper diaphragm 2. The two diaphragms 1 and 2 are therefore placed one above the other and extend above the bottom 21 of the mold 20, and in particular, above the forming surface 22.

In the same way as for the first diaphragm 1, a positioning device makes it possible to create a sealed chamber between the lower diaphragm 1 and the upper diaphragm 2. This chamber is called the second chamber 4 or inter-diaphragm chamber. Sealing is provided by any suitable means.

In the example illustrated, a gasket 16 is provided between the upper side of frame 11 and the upper diaphragm 2 and a frame 12 is placed on the upper diaphragm 2 to support frame 11 and clamp the upper diaphragm 2. Clamping systems 17b, comprising a hook 18b on frame 12 and a fastener 19b on the outside of the peripheral wall 25 of mold 20, are used to clamp the upper diaphragm 2 and secure frame 12. In the example illustrated, a groove 15 is provided on the top face of frame 11, to allow insertion of gasket 16. An abutment is also provided on frame 11 to enable frame 12 to be positioned and adjusted. Any other clamping system such as bolt or tie clamping can also be used in place of the fasteners 17a and/or 17b. The frames hold the diaphragms on the mold.

In the example illustrated, frames 11 and 12 and gaskets 16 and clamping systems 17a and 17b form a positioning device 9 to form the two sealed chambers 3 and 4.

The thickness of frame 11 defines the space between the two diaphragms and thereby influences the initial volume V2 of the second chamber 4. The thickness of this frame 11 can be varied, depending on the thickness of the composite material I to be shaped and the size of the final desired part. For example, for pieces with a greatest dimension of 50 cm, the thickness may be only a few centimeters or even less. For parts larger than 2 m, the thickness is increased for easier handling and to prevent the frame from deforming (bending under its own weight or warping).

In the example illustrated in FIG. 3A, which illustrates the device before any change in pressure in either chamber and thus at the beginning of the process after the various elements of the device are assembled (end of operation a3), the lower diaphragm 1 is placed at a distance from the top 27 of the protrusion 23, which could already be in contact. Similarly, the upper diaphragm 2 is placed at a distance from the composite material I, which could also already be in contact. Advantageously, the maximum distance between the upper diaphragm 2 and the reinforcement material I on the one hand, and the maximum distance between the lower diaphragm 1 and the highest part of the bottom 21 of the mold 20 (top 27 of the protrusion 23 in the example illustrated) on the other hand, will preferably be at most 20 cm, and preferably would correspond to a distance of 0.5 cm to 15 cm.

Mold 20 is equipped with an outlet valve 32 allowing all or part of the air or gaseous medium III (also referred to as gas III) contained inside the first chamber 3 formed by mold 20 and the lower diaphragm 1 to be removed. Thus, given the flexible and elastic nature of the lower diaphragm 1, this valve 32 will make it possible to reduce the volume V1 of the first chamber 3, or even reduce its pressure P1, when the minimum volume of this chamber has been reached.

In contrast, the inter-diaphragm chamber 4 is equipped with an outlet valve 30 allowing the removal of all or part of the air or gaseous medium III contained inside it, but also with an inlet valve 31 allowing the addition of air or another gaseous medium III inside the inter-diaphragm chamber 4. Thus, given the flexible and elastic character of the two diaphragms 1 and 2, these valves will make it possible to vary the volume V2 of the second inter-diaphragm chamber 4 and/or its pressure P2. In particular, within the scope of the invention, it will be possible to increase the volume V2 at some stages of the process, in order to reduce the mechanical stresses applied to the composite material I, by controlling the contact zones, by compensating, in particular, for the decreases in volume V1 and to offer an additional degree of deformation to the composite material I, during an intermediate forming phase.

The two diaphragms 1 and 2 being elastically deformable, or even plastically deformable, but impermeable to gas III, and the formed chambers being gas-diffusion proof when the valves are in the closed position, thereby preventing gas transfers through the diaphragms or due to the presence of leaks, in particular during gas withdrawal or injection operations, and thus an adequate control of the volumes V1 and V2 of chambers 3 and 4 is achieved by means of the valves.

In the example illustrated, passages for said valves 30 and 31 are arranged in frame 11 that is positioned between the two diaphragms 1 and 2.

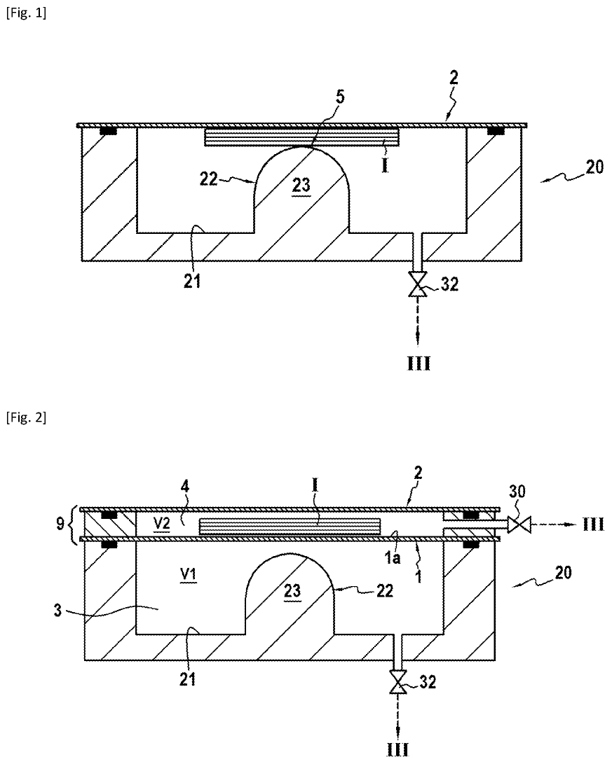

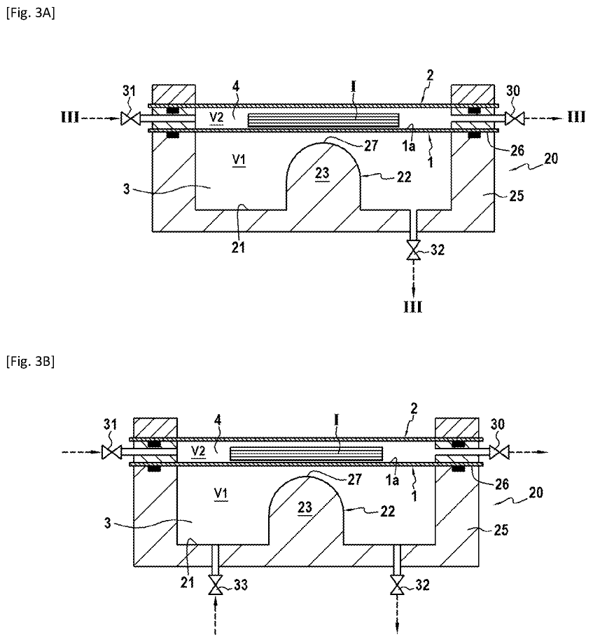

By comparison, FIGS. 1 and 2 illustrate, respectively, the single- and the dual-diaphragm devices of the prior art, using the same reference characters for the parts of the device common to those of the invention.

According to one embodiment for a device according to the invention, as illustrated in FIG. 3B, the first chamber 3 may also be equipped with an inlet valve 33, allowing a gaseous medium to enter into said chamber 3.

In the examples illustrated, the outlet valve 32 and the inlet valve 33 for the gas III, at the level of the first chamber 3, are positioned in the bottom 21 of the mold 20 and on both sides of the protrusion 23. However, their positioning has no effect, since an equilibrium is established in the first chamber 3. Therefore, they can be positioned on the same side of protrusion 23. Similarly, one and/or the other can be positioned, not on the bottom 21, but rather on the peripheral wall 25 of the mold 20.

The inlet and outlet valves make it possible to modulate the displacements of the first and second diaphragms 1 and 2, and thereby vary the volume and/or pressure of the first and second chambers 3 and 4.

The first diaphragm 1 controls the positioning of composite material I initially and helps to maintain its position during its gravitational displacement and affects the degree of progress of the forming operation. When the inter-diaphragm pressure P2 is sufficiently low, after the minimum volume V1 of the first chamber 3 is obtained, the first diaphragm 1 contributes to compaction of the composite material I. The second diaphragm 2 helps to guide and hold the composite material I in place throughout the forming process, and plays a role in forming and the control of its progress. When the inter-diaphragm pressure P2 is sufficiently low, after the volume V1 of the first chamber 3 is obtained, the upper diaphragm 2 also contributes to compaction of the composite material I.

It should be noted that the addition of gas to and the removal of gas from the first and second chambers 1 and 2 may result in variations in the volume of these chambers or to variations in pressure. These changes will have an effect on the pressure and thereby on the mechanical forces and stresses applied to the diaphragms and the composite material, and thereby on the final properties of the resulting preformed composite material. It should be emphasized that the pressure within a chamber will decrease primarily in relation to the volume, if the volume of the space contained in this chamber is difficult to reduce (contact between deformed materials, contact between deformed and rigid materials, response in tension with low elongations of the deformed materials). In contrast, the volume of a chamber develops mainly in relation to the pressure, if one or more compressible spaces exist under a diaphragm or if the responses in tension of the materials are either weak or have a great potential of elongation.

In the device according to the invention, when the gas inlet valve 31 in the second chamber 4 allows an increase in pressure P2 to occur, this will make it possible to mechanically release the fibers and/or plies of composite material I; when it allows an decrease in the volume V2 to occur, it will also make it possible to give a certain degree of freedom to composite material I and to diaphragms 1 and 2 and to modulate the contact interactions (and particularly to reduce friction) between the various elements.

When the gas outlet valve 30 from the second chamber 4 causes a decrease in pressure P2, this makes it possible to mechanically constrain the composite material I (according to the conventional dual-diaphragm operation), when it causes a decrease in the volume V2, this makes it possible to contribute to forming the composite material I.

At the level of the first chamber 3, the gas outlet valve 32 from the first chamber 3 has the primary function of reducing the volume V1 of the first chamber 3, thereby making it possible to proceed with the forming process up to the final pressing on the forming surface 22.

The gas inlet valve 33 in the first chamber 3, is primarily used to decrease the pressure and release the lower diaphragm 1, and thereby reduce friction, especially during cooling.

FIG. 9, in contrast, illustrates the case of a device according to the invention which comprises an external circuit 34 for the circulation of the gas III from the first chamber 3 to the second chamber 4. In particular, this circuit connects the outlet valve 32 of the first chamber 3 to the inlet valve 31 of the second chamber 4. This has the advantage of reinjecting into the second chamber 4 the gas evacuated from the first chamber 3, and thereby holding the overall volume of the two chambers substantially constant, during certain phases of the process, in the intermediate forming phase, as will be explained.

Typically, the valves are connected to a circuit equipped with a gaseous medium flow and pressure regulator, and in particular an air pressure regulator (not illustrated), which makes it possible to withdraw or inject a gaseous medium, depending on the nature of the valve (outlet or inlet) in the chamber concerned. The circuits may therefore include a gas injection pump or a gas pressure reduction pump connected to the valve concerned, or any other device suitable for injection or suction when the valve concerned is in the open position.

Devices according to the invention are suitable for shaping (or preforming) a composite material in the form of a plate, in accordance with the processes according to the invention.

A process according to the invention, for which steps of some alternate embodiments are illustrated in FIGS. 6 to 8, comprises first of all a positioning phase (a) which includes the following operations (steps (a1) and (a2) are not illustrated):
(a1) providing a mold 20 having a non-planar bottom that defines a forming surface 22 corresponding to the shape to be given to the composite material I to be preformed,
(a2) providing, above the mold bottom 21, a first diaphragm, referred to as the lower diaphragm 1, on which the composite material I to be preformed is deposited, and a second diaphragm extending above the composite material I, referred to as the upper diaphragm 2, said two diaphragms 1 and 2 being elastically deformable and impermeable to gas III, and said composite material I being placed above the forming surface 22,
(a3) positioning the two diaphragms 1 and 2 with the mold 20, so as to form:
   a first sealed chamber 3 between the mold 20 and the lower diaphragm 1, said first chamber 3 defining a first modular volume V1, and
   a second sealed chamber 4 between the two diaphragms 1 and 2, said second chamber 4 defining a second modular volume V2, referred to as the inter-diaphragm volume, the composite material I being housed in this volume V2.

In general, in step (a2), the upper diaphragm 1 is first placed above the mold 20, then the composite material I is placed in the desired position with respect to the forming surface 22, particularly through the use of alignment marks, and finally the upper diaphragm 2 is positioned. It also possible to arrange beforehand the two diaphragms 1 and 2 to form the second chamber 4 in which the composite material is positioned and to place the assembly on mold 20 to the form the first chamber 3 and to hold the whole assembly together, according to any appropriate holding or clamping system. It is understood that, before being placed on the first diaphragm 1, the composite material I should have the desired dimensions, which may require cutting beforehand.

At the end of phase (a3), a device in which a composite material is positioned, as illustrated in FIG. 3A or 3B, is obtained. In the examples illustrated, after step (a3), there is no contact between the upper diaphragm 2 and the composite material I, nor between the lower diaphragm 1 and the forming surface 22, but contact at either of these locations could occur from the outset, due to the initial positioning of the various elements and the dimensions of the device.

In the process according to the invention, so as to favor the gravitational descent of the composite material I, while avoiding its sliding on the lower diaphragm 1, particularly during steps (a2) and (a3) of the positioning phase, the lower diaphragm 1, or even both diaphragms 1 and 2, is (are) positioned horizontally, at the end of step (a3), or even during steps (a2) and (a3).

Within the scope of the invention, as is also the case in the processes of the prior art, referred to as dual-diaphragm processes, this positioning phase (a) is completed by the following operations:
(a4) evacuation of the gas III contained in the second chamber 4, thereby reducing the inter-diaphragm volume V2, so that the two diaphragms 1 and 2 are both in contact with the composite material I,
(a5) local alignment of the lower diaphragm 1 on the forming surface 22 in at least one contact zone 5, the composite material I and both diaphragms 1 and 2 also being in contact at said contact zone 5.

This alignment can correspond to a separate operation and can be obtained by evacuating the gas contained in the first chamber 3, which leads to a decrease in the volume V1 and a descent of the lower diaphragm 1 which carries with it the reinforcing material and the upper diaphragm 2, given the operation (a4) which will have been performed beforehand, according to the successive steps (a3) to (a5) illustrated in FIG. 6. Also, according to a preferred embodiment, operation (a5) is performed after operation (a4) by evacuating the gas Ill into the first chamber 3, resulting in the reduction in the volume V1, so as to establish a pre-contact between the lower diaphragm 1 and the forming surface 22, while the volume V2 of the second chamber 4 is held constant. Evacuating the gas from the second chamber 4 is accomplished by opening the outlet valve 30, while the evacuating of the gas from the first chamber 3 is accomplished by opening the outlet valve 32. After the composite material I has been compressed between the two diaphragms, the outlet valve 30 can be closed or held open if the desired pressure level has not been reached when the volume V1 is reduced, if this reduction is necessary for local alignment.

It is also possible for the lower diaphragm 1 to be in contact with the forming surface 22 from the outset. An initial alignment can be obtained at the end of the operation (a3) and maintained at the end of the operation (a4). It is also possible that even if after operation (a3), diaphragm 1 is in contact with the forming surface 22, it may slightly lift off the forming surface during operation (a4), in which case a subsequent alignment step (a5) will be necessary.

Irrespective of the embodiment, the alignment corresponds to a pre-contact between the lower diaphragm 1 which will be abutted on the highest part of the forming surface 22. It is a local contact and not a pressing over the entire forming surface, contrary to what will be obtained at the end of the intermediate forming phase. If there are several embossments on forming surface 22, it is possible that alignment occurs on several contact areas 5.

At the end of step (a5), the pressure P2 of the second chamber 4 is lower than the pressure P1 of the first chamber 3, which is itself lower than the external pressure Pext, and in particular the atmospheric pressure, when the external pressure Pext is equal to the atmospheric pressure.

Operation (a4), in contrast, consists in reducing the volume V2 of the inter-diaphragm chamber, particularly to its minimum volume, so as to hold the composite material tightly between the two diaphragms 1 and 2. Thus at the end of operation (a4) and thereby of phase (a), the composite material I is compressed between the two diaphragms 1 and 2, with a maximum contact surface with the latter.

At the end of step (a), contact is established between the lower diaphragm 1 and the highest part 27 of the forming surface 22 at a contact zone 5. However, at this contact zone 5, it is the lower diaphragm I/composite material I/upper diaphragm 2 assembly that is positioned in contact with the highest part 27 of the forming surface 22, as a result of step (a4).

Step (a4) can result in a more or less reduced pressure P2 in the inter-diaphragm chamber 4. At the end of step (a4) and at the end of step (a5), and thus at the end of the positioning phase (a), the composite material I is firmly held between the two diaphragms 1 and 2, thereby ensuring good positioning on the forming surface 22. Nevertheless, at the end of step (a4) and at the end of step (a5), and therefore at the end of the positioning (a), it is preferable that the pressure P2 within inter-diaphragm chamber 4 is intermediate, so as not to excessively stress the composite material. In particular, the pressure P2 is preferably between 600 mbar and 950 mbar, if the external pressure is equal to atmospheric pressure. Such a pressure makes it possible to limit mechanical stresses within the composite material I, especially at the level of the interlayers in the most frequent cases where the composite material is a stack of several reinforcement sheets. However, a pressure P2, in the range from 2 mbar to 1000 mbar, can also be provided, if the external pressure is equal to atmospheric pressure.

At the end of the positioning phase (a), the forming device is thereby constituted and the material is in place in it, and forming can then be initiated. The forming device/composite material I assembly can be placed in an ambient atmosphere, so that the pressure outside the device, referred to as Pext, is equal to atmospheric pressure (or 1.013 bar). It is also possible that the forming device/composite material I assembly can be placed in a variable pressure enclosure, such as an autoclave. The pressures given in the rest of the description are particularly suitable in the case where the forming device/composite material I assembly is placed under atmospheric pressure, but these can be easily modified by a person skilled in the art, if necessary, according to the external pressure.

After the positioning phase (a), the process according to the invention comprises an intermediate forming phase (b), during which at least the following operations are performed:
introduction of the gas III into the second chamber 4, while maintaining the pressure P2 below the external pressure Pext, and in particular atmospheric pressure, when the external pressure Pext is equal to atmospheric pressure, thereby locally maintaining the upper diaphragm 2 at a distance from lower diaphragm 1 and from composite material I, while maintaining, in the contact zone 5, both the alignment and the contact between the composite material I and the two diaphragms 1 and 2,
evacuation of the gas III contained in the first chamber 3, so as to press the lower diaphragm 1 over the entire forming surface 22 present at the bottom 21 of the mold 20.

Within the scope of the invention, the control of the pressure and the introduction of gas into the second chamber 4 which allows the volume of chamber 4 to increase makes it possible to give a certain degree of freedom to the composite material and to the diaphragms and to mechanically release the fibers, or even the plies, which make up the composite material. It is therefore possible to reduce defects on the material in final form, as compared to a dual-diaphragm process of the prior art.

However, by maintaining the first diaphragm 1/composite material I/second diaphragm 2 in contact at least in contact zone 5, the positioning of the composite material can be controlled and the desired shape can be achieved, as is the case for a dual-diaphragm of the prior art. Throughout the process, and in particular throughout the intermediate forming phase (b), the contact of both diaphragms 1 and 2 is maintained with the composite material I, at least in contact zone 5, with the diaphragm/composite material assembly resting on forming surface 22. At the highest area of the forming surface, both the alignment and the contact between composite material I and the two diaphragms 1 and 2 are maintained, which secures the positioning of the material on the mold and on the forming surface and prevents a shift due to the weight of composite material I.

In general, the introduction(s) and withdrawal(s) of the gas III are performed in such a way that the pressure P1 in the first chamber 3 and the pressure P2 in the second chamber 4 are controlled and/or modified, and that the pressure P1 remains lower than the pressure P2, which is itself lower than the external pressure Pext, and in particular atmospheric pressure, when the external pressure Pext is equal to atmospheric pressure.

When heating is used, it will have an effect on the volume of gas and/or the gas pressure in the chambers, or even on the volume occupied by the composite material. In general, the final heating temperature will be reached gradually and the volume of the first chamber or even the second chamber will be regulated during this temperature rise until the desired final temperature is reached, in order to avoid an increase in the volume of the chamber concerned. Also, when the temperature rises to the desired heating temperature, outlet valve 32 can be activated and gas can be withdrawn from the first chamber 3 to control the volume V1 and prevent it from increasing, holding it substantially constant. Likewise, the outlet valve 30 can be activated and gas can be withdrawn from the inter-diaphragm chamber 4 to control the volume V2 and prevent it from increasing, holding it substantially constant.

When heating is applied, it has an effect on the volume of gas and/or the gas pressure in the chambers, or even on the volume occupied by the composite material. In general, the final heating temperature is reached gradually and the volume of the first chamber or even the volume of the second chamber is regulated during this temperature rise until the desired final temperature is reached, in order to avoid an increase in the volume of the chamber concerned. Also, when the temperature rises to the desired heating temperature, outlet valve 32 can be activated and gas can be withdrawn from the first chamber 3 to control the volume V1 and prevent from it increasing, holding it substantially constant. Similarly, the outlet valve 30 can be activated and gas can be withdrawn from the inter-diaphragm chamber 4 to control the volume V2 and prevent it from increasing, holding it substantially constant.

According to one embodiment of the invention illustrated in FIG. 6, the introduction of the gas Ill into the second chamber 4, locally maintaining the upper diaphragm 2 and the lower diaphragm 1 at a distance, and evacuating the gas Ill contained in the first chamber 3, causing the lower diaphragm 1 to be pressed on the bottom of the mold 21, can be performed simultaneously. In this case, the intermediate forming phase is performed by evacuating the gas Ill contained in the first chamber 3, so as to press the lower diaphragm 1 on the forming surface 22 positioned at the bottom 21 of the mold, while introducing the gas III into the second chamber 4 and maintaining the pressure P2 in the second chamber 4 below the external pressure Pext, and in particular atmospheric pressure, when the external pressure Pext is equal to atmospheric pressure and, thus, increase the inter-diaphragm volume V2, and locally maintaining the upper diaphragm 2 at a distance from the lower diaphragm 1 and composite material I, while maintaining, in contact zone 5, both the alignment and the contact between composite material I and both diaphragms 1 and 2. In fact, under the effect of gravity, the composite material I deforms according to its flexural properties and according to the geometry and surface of the contact zone 5. As a result, a separation occurs between the upper diaphragm 2 and the composite material I, with the ends of the composite material I moving away from the upper diaphragm 2, as illustrated in FIG. 6. By simultaneously holding open the inlet valve 31 at the inter-diaphragm chamber 4 and the outlet valve 32 at the first chamber 3, it is possible to allow the composite material I a certain degree of freedom before it is placed on the lower diaphragm 1 and thus on the forming surface during the final forming and compaction step. In addition, after phase (b) has been initiated, the pressure P2 will, in most cases, be held substantially constant during this preforming phase (b) to prevent displacement of the upper diaphragm 2.

Generally, in the processes according to the invention, the gas injection or suction flow rates in the chambers will be modified by a person skilled in the art, according to various parameters, in particular the valves selected, the diameter of the pipes in the gas circulation circuit, the size of the mold, any pressure drops in the circuit, and the like.

During the preforming phase (b) and therefore also at the end of this phase, the pressure P1 in the first chamber 3 is lower than the pressure P2 in the second chamber 4. At the end of the preforming phase (b), the preforming pressure P1 (b) is generally in a range from 2 mbar to 50 mbar.

In this embodiment, the decrease in the volume V1 of the first chamber 3 can be equal or approximately equal to the increase in the volume V2 of the second chamber 4. As illustrated in FIG. 6, it is also possible that the increase in the volume V2 of the second chamber 4 is lower, in particular by 5% to 10%, as compared to the decrease in the volume V1 of the first chamber 3, which will result in a more or less marked movement towards the bottom of the mold of the upper diaphragm 2, although it remains at a distance from certain areas of the forming surface.

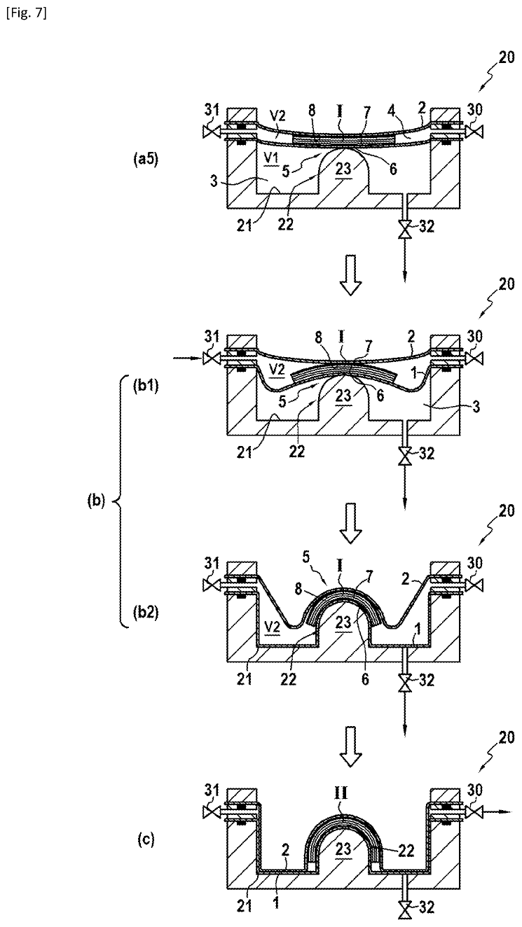

According to the second alternate embodiment illustrated in FIG. 7, the intermediate forming phase (b) includes, or even includes only the following successive operations:
(b1) evacuating the gas III contained in the first chamber 3, resulting in the reduction in the volume V1, and the descent of the lower diaphragm 1, in an intermediate position, while introducing the gas III into the second chamber 4 and maintaining the pressure P2 in the second chamber 4 below the external pressure Pext, and in particular atmospheric pressure, when the external pressure Pext is equal to atmospheric pressure and, thereby increasing the inter-diaphragm volume V2, and locally maintaining the upper diaphragm 2 at a distance from the lower diaphragm 1 and composite material I, while maintaining, in contact zone 5, both the alignment and the contact between composite material I and both diaphragms 1 and 2,
(b2) evacuating the gas III contained in the first chamber 3, and thereby pressing the lower diaphragm 1 over the entire forming surface 22 present at the bottom 21 of the mold 20, while holding constant the inter-diaphragm volume V2.

Here again, in step (b1), the decrease in the volume V1 of the first chamber 3 may be equal to or approximately equal to the increase in the volume V2 of the second chamber 4, as illustrated in FIG. 7. It is also possible that the increase in the volume V2 of the second chamber 4 may be lower, in particular by 5% to 10%, as compared to the decrease in the volume V1 of the first chamber 3, which will result in a more or less marked movement of the upper diaphragm 2 towards the bottom of the mold, although it is maintained at a distance from certain areas of the forming surface. The displacement of the upper diaphragm 2 will also depend on the pressure equilibrium between chambers 3 and 4. Step (b1) is performed by simultaneously holding open the inlet valve 31 at the level of the inter-diaphragm chamber 4 and the outlet valve 32 at the level of the first chamber 3, and the inlet valve 31 is closed and the outlet valve is held open to obtain pressing of the lower diaphragm 1 on the forming surface, in step (b2).

Therefore, in the case of the process illustrated in FIG. 7, the upper diaphragm 2 moves, as a function of the movement of the lower diaphragm 1 (which has moved forward from step (a5) to step (b1)). In this case, the upper diaphragm 2 is deformed and tightens more and more during the progress of step (b), and in particular of step (b2), which results in a change in the pressure P2 of the second chamber 4. Advantageously, the volume V2 is held substantially constant, or even constant, throughout phase (b).

During step (b1), the pressures in the chambers depend, in particular, on the mechanical properties of the diaphragms. In step (b2), when the lower diaphragm 1 is in contact with the forming surface 22, the pressure P1 in the first chamber 3 can be between 2 mbar and 50 mbar. In step (c), when the upper diaphragm 2 is in contact with the composite material I, which is itself pressed on the lower diaphragm 1, which is itself pressed on the forming surface 22, the pressure P2 in the second chamber 4 can be between 2 mbar and 50 mbar.

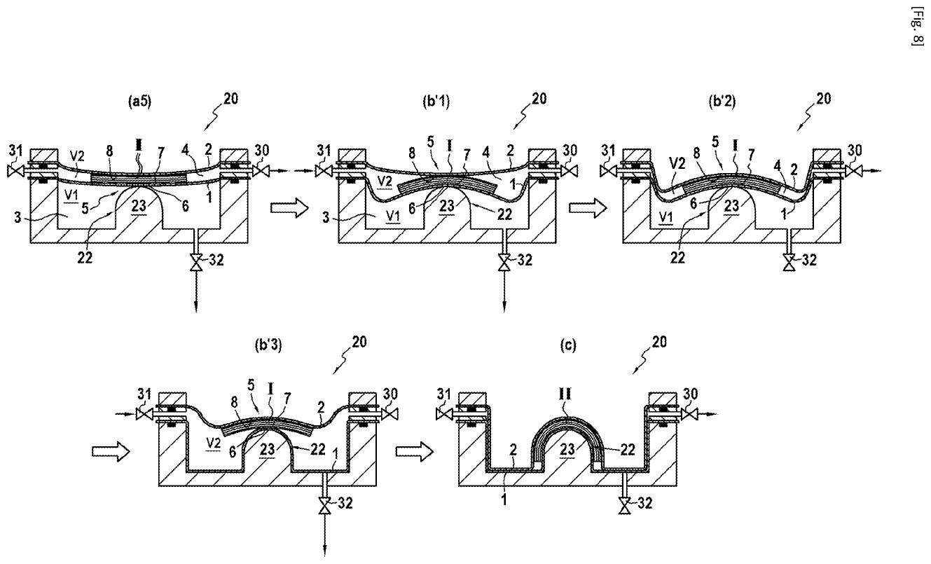

According to a third alternate embodiment illustrated in FIG. 8, the intermediate forming phase (b) includes, or even includes only, the following successive operations:
(b′1) evacuating the gas III contained in the first chamber 3, resulting in the reduction in the first volume V1, and to the descent of the lower diaphragm 1, in an intermediate position, while introducing the gas Ill into the second chamber 4 and maintaining the pressure P2 in the second chamber 4 below the external pressure Pext, and in particular atmospheric pressure, when the external pressure Pext is equal to atmospheric pressure and, thus, increase the inter-diaphragm volume V2, and locally maintaining the upper diaphragm 2 at a distance from the lower diaphragm 1 and composite material I, while maintaining, in contact zone 5, both the alignment and the contact between composite material I and both diaphragms 1 and 2,
(b′2) evacuating the gas III contained in the second chamber 4 and thus reducing the inter-diaphragm volume V2, and resulting in the descent of the upper diaphragm 2 and the placement of the two diaphragms 1 and 2 both in contact with the composite material I,
(b′3) evacuating the gas III contained in the first chamber 3, and thereby pressing the lower diaphragm 1 over the entire forming surface 22 present at the bottom 21 of the mold 20, while introducing the gas III into the second chamber 4 and maintaining the pressure P2 in the second chamber 4 below the external pressure Pext, and in particular atmospheric pressure, when the external pressure Pext is equal to atmospheric pressure and thus increasing the inter-diaphragm volume V2, and locally maintain the upper diaphragm 2 at a distance from the lower diaphragm 1, while maintaining, in contact zone 5, both the alignment and the contact between the composite material I and both diaphragms 1 and 2.

Here again, in operation (b′1) and/or operation (b′3), the decrease in the volume V1 in the first chamber 3 may be equal or substantially equal to the decrease in the volume V2 in the second chamber 4, as illustrated in FIG. 8. It is also possible that the decrease in the volume V2 in the second chamber 4 may be lower, in particular by 5% to 10%, as compared to the decrease in the volume V1 in the first chamber 3, which will result in a more or less marked movement towards the bottom of the mold of the upper diaphragm 2, although maintained at a distance on certain areas of the forming surface. The displacement of the upper diaphragm 2 will also depend on the pressure equilibrium between chambers 3 and 4. Step (b′1) is performed by simultaneously maintaining the inlet valve 31 in the open position at the level of the inter-diaphragm chamber 4 and the outlet valve 32 at the level of the first chamber 3. Then, in step (b′2), these two valves are closed and the outlet valve 30 at the level of the second chamber 4 is open, allowing the upper diaphragm 2 to descend onto the composite material I. In step (b′3), the outlet valve 30 is closed and valves 31 and 32 are open again, as in step (b′1).

As can be seen in the illustration in FIG. 8, between steps (b′2) and (b′3), the upper diaphragm 2 does not move, but then moves downward in step (b′3), and possibly upstream, in a repetition of steps (b′1) and (b′2), until the final compression of the composite material in step (c).

It is possible to repeat steps (b′1) to (b′2), for example, one to ten times, and thereby gradually cause the descent of the lower diaphragm 1 and then the upper diaphragm 2 until the lower diaphragm 1 is pressed on the forming surface 22. According to the third alternate embodiment, the intermediate forming phase (b) may consist only of a repetition of operations (b′1) to (b′2), followed by a final operation (b′3). The number of repetitions will depend on the reduction in the volume V1 obtained at the end of each step (b′1). During steps (b′1), there is a progressive descent of the first diaphragm 1, with the exception of the part already on the forming area at contact zone(s) 5 and this contact zone extends progressively. Step (b′2) requires the upper diaphragm 2 and composite material I to follow the movement of the lower diaphragm 1, although the descent of the lower diaphragm 1 in step (b′1) is usually accompanied by the descent of the reinforcing material, as illustrated in FIG. 8.

In this third alternate embodiment illustrated in particular in FIG. 8, in general, during step (b′1), P1<P2<Patmo, with in particular 50 mbar<P1<950 mbar and 50 mbar<P2<Patmo, and during step (b′2), 50 mbar<P1<950 mbar and 50 mbar<P2<950 mbar. In step (b′3), the pressures in the chambers may, in particular, be such that 2 mbar<P1<50 mbar and 50 mbar<P2<950 mbar.

In general, in the processes according to the invention, the two diaphragms only move downward throughout the process. It is, however, not excluded that the upper diaphragm 2 may rise slightly, especially when gas is added to the inter-diaphragm space.

Similarly, in the processes according to the invention, in the contact zone 5, a contact 6 is maintained between the lower diaphragm 1 and the forming zone 22, a contact 7 is maintained between the lower diaphragm 1 and the composite material I, and a contact 8 is maintained between the composite material I and the upper diaphragm 2. As the process progresses, this area of contact between the various elements expands until the lower diaphragm 1/composite material I/upper diaphragm 2 assembly is fully pressed over the entire forming area 22, or even more.

At the end of the intermediate forming phase (b), irrespective of the alternate embodiment, the pressure P1 in the first chamber 3 will advantageously be in a range from 2 mbar to 50 mbar, typically 2 mbar to 5 mbar.

The process according to the invention, irrespective of the intermediate forming phase (b) used, comprises the following steps:
a final forming and compaction phase (c) that results in the desired final shape of the preformed composite material II, during which heating is applied, during which the gas Ill contained in the second chamber 4 is removed, so as to press both the composite material I and the upper diaphragm 2 onto the lower diaphragm 1, which is itself pressed onto the bottom of the mold 21, in particular onto the forming surface 22, and to obtain a reduction in pressure P2, so as to ensure compaction,
a cooling and unmolding phase (d) of the preformed composite material II.

At the time of phase (c), the outlet valve 30 is activated to evacuate the gas III contained in the inter-diaphragm chamber 4, and to thereby reach the minimum volume V2. After this volume is achieved, the pressure P2 is also reduced. During final forming and compaction, the pressure P2 in inter-diaphragm chamber 4 is typically in a range from 2 mbar to 50 mbar, typically 2 mbar to 5 mbar. After such a pressure has been reached, outlet valve 30 can be closed. Generally, suction is maintained to secure the operation.

As a function of the dimensions of the forming surface 22 and the intermediate material I, when pressing is obtained in step (c), the lower diaphragm 1/composite material I/upper diaphragm 2 assembly may cover only the forming surface 22 or part of it as illustrated in the last step of FIGS. 6 and 7 or may also cover a flat part of the bottom of the mold or even the entire bottom 21 of the mold 20, which reduces the risk of diaphragm rupture.

During step (c), the outlet valve 32 of the first chamber 3 can be closed or held open. During final forming and compaction, the pressure P1 in the first chamber 3 is usually in a range from 2 mbar to 50 mbar, typically 5 mbar.

In order to achieve consolidation of the part, the time required to maintain the heating under reduced pressure, in phase (c) where the composite material is kept compressed between the two diaphragms to achieve the desired final shape, depends on the thickness of the composite material and the nature of the polymer thermoplastic material, in particular. In general, phase (c) will last from 2 minutes to 5 hours. Afterwards, cooling prior to unmolding can take place, in order to freeze the shape obtained in phase (c). For this purpose, heating is simply switched off and the return to room temperature takes place naturally.

Irrespective of the process according to the invention and in particular the intermediate forming phase implemented, during the cooling phase, the pressure in the first chamber 3 may be increased by activating the inlet valve 33 at the level of the first chamber 3, using a device such as the one illustrated in FIG. 3B. Such an increase in pressure, especially to reach a value in a range from 850 mbar at atmospheric pressure, reduces the friction between the lower diaphragm 1 and the mold 20, thereby facilitating sliding between the diaphragm/composite material assembly and the mold, and further reducing the risk of defects. This sliding occurs due to differences in thermal expansion between the mold and the diaphragm/material assembly

After cooling and freezing the shape obtained, the preformed composite material II can be removed from the mold after the device has been returned to external pressure, and in particular to atmospheric pressure. The device can then be re-used, if the nature of the diaphragms allows it.

The external pressure Pext can be varied. If the external pressure Pext is varied during the process, in particular if the device is placed in an autoclave, the increase in the external pressure Pext can be achieved before the implementation of phase (b) and/or phase (c). On the other hand, in general, the external pressure Pext is held constant throughout phase (b) and throughout phase (c), even if the external pressure is increased before either of these phases. By way of example, if the device is placed in an autoclave, the external pressure Pext can be increased to a value in a range from 1 bar to 20 bar and held at this value during phases (b) and (c), or even during the cooling phase. The pressures P1 and P2 given hereinabove, by way of example, will then be varied accordingly.

It follows from the preceding description that the processes and devices according to the invention offer a great deal of flexibility. They make it possible both to guarantee the control and positioning of the composite material I to be molded, throughout the process, and result in forming according to the desired shape with no displacement. In contrast, the possibility of increasing the volume of the inter-diaphragm chamber 4 during the descent of the lower diaphragm 1, during one or several preforming (b) phases, makes it possible to give a certain degree of freedom to the fibers of the composite material, or even to the plies of the composite material if the composite material is in the form of a stack, and to avoid plies or other defects caused, if excessive mechanical stresses are imposed on the composite material I during its forming. The invention thus offers many potential paths to optimization by means of adjusting these parameters.

Furthermore, the implementation of the processes and devices according to the invention can be fully automated, taking into account the reliability of the placement of composite material I, by means of the use of the two diaphragms 1 and 2 and to the control of the various parameters of the process which can be fully computerized. In general, a forming cycle using a process according to the invention will be on the order of 5 minutes to 15 minutes, in the absence of heating, and may reach 1 hour to 12 hours, when heating is used. The process according to the invention may result in a final part in the case of the use of a composite I prepreg. In the case where the composite material is said to be “dry”, the process according to the invention will result in a preform which will then be associated with a polymer matrix, in order to obtain the desired final part, by implementing a direct process well-known to a person skilled in the art.

The following examples illustrate the invention, but are in no way limiting.

### EXAMPLES

In the examples, stacks of composite materials, each consisting of a unidirectional web of IMA 12K carbon fibers marketed by Hexcel Corporation, combined on each side with a 4 g/m² copolyamide 1R8 fiber web from Protechnic, were used. The polymer veil was combined with the unidirectional carbon web in accordance with application WO 2010/046609.

Comparative tests 1a, 1b and 1c, as well as Examples 1 and 2 were performed with 16 superimposed plies of such a material, which are joined together by automatic AFP dispensing with heating to form a stack I, in the form of a plate with dimensions 750 mm*450 mm*3.1 mm. The weight % of plastic (the copolyamide) in the final stack I was 3.6%, based on the weight of the stack.

In all cases, irrespective of one or more diaphragms being used, they were 75 μm thick Ipplon DP1000 nylon diaphragms distributed by Airtech, Great Britain.

The temperature used for the intermediate and final forming and compaction operations was 170° C. and the unmolding temperature was 25° C. The temperature was raised to 170° C. at a rate of 1.5° C./min and took 6 hours.

The mold 20 used was in the form of a tank having dimensions 2000 mm*1000 mm*320 mm. At the bottom 21 of the mold, in its middle and extending parallel to its long side, there was a protrusion 23, corresponding to the forming surface 22. The shape and dimensions of this protrusion are given in FIG. 10. The seal between the mold 20 and the diaphragm and, when two diaphragms 1 and 2 were used, between the two diaphragms 1 and 2 to form a closed inter-diaphragm space (called second chamber 4), was ensured by the use of two gaskets 16 and by the superposition of frames 11 and 12 and clamping systems 17a and 17b, as illustrated in FIGS. 4 and 5. In the case of the use of a single diaphragm, only one sealing gasket 16 extending all along the peripheral edge 26 of mold 20 was used, this gasket being positioned between the edge of the mold and the diaphragm. A frame equivalent to frame 11 in FIG. 5 was then positioned and tightened on the diaphragm.

In the comparative examples and according to the invention, the forming device was in an ambient atmosphere, so that the pressure outside the forming device was equal to atmospheric pressure, namely 1.013 bar, or 1013 hPa.

Surface analyses to demonstrate the presence or absence of defects were performed by means of a 3D Scanner using Creaform technology.

### Comparative Example 1a

This comparative example was performed using the previous simple diaphragm technique and thus using a device as described in FIG. 1. The stack was positioned directly at the top of the protrusion present at the bottom of the mold. It was positioned symmetrically with respect to the protrusion, so that the top of the protrusion forming a line extended parallel to its two large sides and in the middle of them. Nevertheless, it was difficult to maintain the stack in balance. The diaphragm was then positioned over the top to hold the stack against the top of the protrusion.

The temperature was then raised to 170° C., followed by evacuation of the air contained between the mold and the diaphragm. The compaction operation was performed by maintaining a pressure of 5 mbar and a temperature of 170° C. for 30 minutes. Then, the heating was discontinued and after the temperature returned to room temperature, the resulting shaped stack was removed from the mold.

The total surface area (that is, inner and outer sides) of the resulting preform, corresponding to 284750 mm2, was analyzed and illustrated a total absence of defects.

### Comparative Example 1b

This comparative example was performed using the dual-diaphragm of the prior art and therefore using a device as described in FIG. 2. Contrary to the comparative example 1a, a lower diaphragm 1 was then positioned above mold 20, so as to close it and form a first chamber 3. It was placed at a distance of 2 cm from the top of the protrusion at the bottom of the mold. Stack I was positioned directly on this lower diaphragm 1, above the top of the protrusion, causing the lower diaphragm 1 to come into contact with the top of the protrusion present at the bottom of the mold. It was positioned symmetrically with respect to protrusion 23, so that the top of the protrusion forming a line extends parallel to its two large sides and in the middle of them. It was held in place by the lower diaphragm 1. An upper diaphragm 2 was then positioned above it to trap stack I between the two diaphragms forming a second chamber 4, with a space of 40 mm between diaphragms 1 and 2. The entire device was then locked in place using the clamping systems 17a and 17b illustrated in FIGS. 4 and 5. The process then proceeded as follows: heating to a temperature of 170° C., held until the end of the compaction step, evacuation of the air contained in the inter-diaphragm chamber 4 by means of the outlet valve 30 connected to the inter-diaphragm space, until a pressure of 5 mbar was obtained in the inter-diaphragm chamber 4: the positioning of the stack was thereby secured and detached from the protrusion 23. This valve 30 was then held open to maintain pressure regulation.

The air contained between the mold and the lower diaphragm 1 was evacuated until a pressure of 5 mbar was obtained by means of outlet valve 32 connected to the first chamber 3, with a suction rate of 7.5 m3/h. Thus, the diaphragm/stack assembly was fitted to the shape of the protrusion 23. The final forming and compaction phase was then performed while maintaining this 5 mbar pressure and a temperature of 170° C. for 30 minutes. Afterwards, the heating was discontinued and after the temperature returned to room temperature, the stack in shape Il was removed from the mold.

The volumes and pressures in the two chambers 3 and 4 during the various phases of the process are summarized in Table 2 below.

TABLE 2

| | [lower diaphragm − mold] | | [upper diaphragm − lower | |
|---|---|---|---|---|
| | space | | diaphragm] space | |
| | Pressure | Volume | Pressure | Volume |
| Parameters | (P1) | (V1) | (P2) | (V2) |
| Heating | ~Pₐₜₘₒ | V1 = V_{mold} | P2 = 5 mbar | V2 = V2ₘᵢₙ |
| Intermediate | P1 < Pₐₜₘₒ | V1 = V_{mold} − | P2 = 5 mbar | V2 = V2ₘᵢₙ |
| forming | | Vx | | |
| Final forming | P1 = 5 mbar | V1 = V1 ₘᵢₙ | P2 = 5 mbar | V2 = V2ₘᵢₙ |
| and | | | | |
| compaction | | | | |

In the tables of examples, Pₐₜₘₒ=atmospheric pressure, V_{mold}=volume of air in the space between the lower diaphragm and the mold at the start of the process, Vx=feed volume associated with the first chamber (located between the mold and the lower diaphragm), V1ₘᵢₙ=Volume V1 minimum, V2ₘᵢₙ=Volume V2 minimum.

The total surface area (that is, the external and internal faces 101 and 102) of the preform obtained, corresponding to 285943 mm2, was analyzed and revealed defects on both the internal and external surfaces of preform II corresponding to an area of 32812 mm2, that is, 11.5% of the surface area. FIG. 11 illustrates the plies 200 present on the outer surface 102 of preform II.

### Comparative Example 1c

This comparative example is comparable to comparative example 1b, with the difference that, first of all, air was evacuated into the inter-diaphragm space to reach a pressure of 850 mbar and not 5 mbar. This modification was therefore in accordance with the recommendations of U.S. Pat. No. 9,259,859 and was intended to limit the compaction of the stack during intermediate shaping and thereby facilitate the sliding of the plies in relation to each other.

The volumes and pressures in the two chambers 3 and 4 during the various phases of the process are summarized in Table 3 below.

TABLE 3

| | [lower diaphragm − mold] | | [upper diaphragm − lower | |
|---|---|---|---|---|
| | space | | diaphragm] space | |
| | Pressure | Volume | Pressure | Volume |
| Parameters | (P1) | (V1) | (P2) | (V2) |
| Heating | ~Pₐₜₘₒ | V1 = V_{mold} | P2 = 850 mbar | V2 = V2ₘᵢₙ |
| Intermediate | P1 < Pₐₜₘₒ | V1 = V_{mold} − | P2 = 850 mbar | V2 = V2ₘᵢₙ |
| forming | | Vx | | |
| Final forming | P1 = 5 mbar | V1 = V1 ₘᵢₙ | P2 = 5 mbar | V2 = V2ₘᵢₙ |
| and | | | | |
| compaction | | | | |

In this case, the total surface area of the preform analyzed was 284247 mm2 and the defects represented an area of 14178 mm2, or 5% of the total surface area.

### Example 1

Example 1 was carried out according to the process illustrated in FIG. 6.

After positioning the diaphragms 1 and 2 and stack I, as in comparative example 1b, by opening outlet valve 30, air was evacuated into the inter-diaphragm space (second chamber 4) to reach a pressure of 850 mbar, as in comparative example 1c, while inlet valve 31 was closed. Then, outlet valve 30 was closed. A local alignment of the diaphragm 1 and 2/stack I assembly was then performed on the top 27 of the protrusion 23, by evacuation of the air contained in the first chamber 3 formed by the mold 20 and the lower diaphragm 1 (duration less than 10 seconds). This suction was obtained by activating the outlet valve 32. Then, the suction was continued until the lower diaphragm 1 was pressed on both the protrusion 23 and the bottom of the mold 21, while injecting air into the second inter-diaphragm chamber 4, thanks to the inlet valve 31, thereby maintaining the total volume of chambers 3 and 4 substantially constant (injection time of 5 minutes, with an injection flow rate of 7.5 m3/h. After the minimum volume of the first chamber 3 was reached, the pressure in this first chamber 3 was equal to 5 mbar. The outlet valve 32 was closed and the inlet valve 31 as well. The air contained in the second inter-diaphragm chamber 4 was then evacuated by means of the outlet valve 30, until the minimum volume of this chamber was reached and a pressure of 5 mbar was obtained in it. The final forming and compaction phase was therefore performed with a pressure of 5 mbar, both in the first chamber 3 and the second chamber 4. Its duration was 30 minutes.

Cooling and unmolding were performed as in comparative example 1a.

The volumes and pressures in both chambers 3 and 4 during the various phases of the process are summarized in Table 4 below.

TABLE 4

| | Space [lower diaphragm − | | Space [upper diaphragm − | |
|---|---|---|---|---|
| | mold] | | lower diaphragm] | |
| | Pressure | Volume | Pressure | Volume |
| Parameters | (P1) | (V1) | (P2) | (V2) |
| After heating, | ~Pₐₜₘₒ | V1 = V_{mold} | P2 = 850 | V2 = V2ₘᵢₙ |
| at the end of | | | mbar | |
| step (a4) | | | | |
| at the end of | 850 mbar < | V1 = V_{mold} − | 850 mbar | V2 = V2ₘᵢₙ |
| step (a5) | P1 < Pₐₜₘₒ | ΔV | | |
| at the end of | P1 = 5 mbar | V1 = V1 ₘᵢₙ | 850 mbar < | V2 = V_{mold} − |
| step (b) | | | P1 < Pₐₜₘₒ | ΔV + V2ₘᵢₙ |
| Step (c) | P1 = 5 mbar | V1 = V1 ₘᵢₙ | P2 = 5 mbar | V2 = V2ₘᵢₙ |

The total surface area (that is, the outer and inner sides) of the resulting preform corresponding to 284750 mm2 was analyzed and revealed a total absence of defects.

### Example 2

Example 2 was carried out according to the process illustrated in FIG. 7.

The process is identical to that of example 1 until the diaphragms 1 and 2/stack I are positioned on the top 27 of protrusion 23. Then, evacuating of the air contained in the first chamber 3 formed by the mold 20 and the lower diaphragm 1 was continued until an intermediate pressure of 850 mbar and an intermediate volume were obtained in the first chamber 3, while injecting air into the second inter-diaphragm chamber 4 through inlet valve 31, so as to compensate for the decrease in the volume of the first chamber 3 by increasing the volume of the second chamber 4. Thus, the pressure P2 was held at a substantially constant value of 850 mbars and the two diaphragms were held locally at a distance of about 15 cm from each other in their most remote areas. The inlet valve 31 was then closed and evacuating of the air through the outlet valve 32 was continued until the lower diaphragm 1 was pressed on both the protrusion 23 and the bottom of the mold 21. After the minimum volume of the first chamber 3 was reached, the pressure in this first chamber 3 was equal to 5 mbar. The outlet valve 32 was closed. The air contained in the second inter-diaphragm chamber 4 was then evacuated via by the outlet valve 30, until reaching the minimum volume of this chamber and obtaining a pressure of 5 mbar in this last one. The final forming and compaction operation was therefore performed with a pressure of 5 mbar, both in the first chamber 3 and the second chamber 4, as in example 1.

Cooling and unmolding were carried out as in comparative example 1a.

The volumes and pressures in both chambers 3 and 4 during the various phases of the process are summarized in Table 5 below.

TABLE 5

| | [lower diaphragm − mold] | | [upper diaphragm − lower | |
|---|---|---|---|---|
| | space | | diaphragm] space | |
| | Pressure | Volume | Pressure | Volume |
| Parameters | (P1) | (V1) | (P2) | (V2) |
| After heating, | ~Pₐₜₘₒ | V1 = V_{mold} | P2 = 850 | V2 = V2ₘᵢₙ |
| at the end of | | | mbar | |
| step (a4) | | | | |
| at the end of | 850 mbar < | V1 = V_{mold} − | 850 mbar | V2 = V2ₘᵢₙ |
| step (a5) | P1 < Pₐₜₘₒ | ΔV | | |
| at the end of | P1 < P2 | V1 = V_{mold} − | 850 mbar < | V2 = V_{mold} − |
| step (b1) | | ΔVx | P2 < Pₐₜₘₒ | ΔV + V2ₘᵢₙ |
| at the end of | P1 = 5 mbar | V1 = V1 ₘᵢₙ | 5 mbar < P2 | V2 = V_{mold} − |
| step (b2) | | | < 850 mbar | ΔV + V2ₘᵢₙ |
| Step (c) | P1 = 5 mbar | V1 = V1 ₘᵢₙ | P2 = 5 mbar | V2 = V2ₘᵢₙ |

In the tables for the examples, ΔVx=volume of advance associated with the second chamber 4 (inter-diaphragm space).

The total surface area (that is, the outer and inner sides) of the preform obtained corresponding to 284750 mm2 was analyzed and revealed a total absence of defects.

### Example 3

Example 3 was carried out according to the same process and under the same conditions as in Example 2, but on a different stack. The stack consisted not of 16 plies, but 96 plies, resulting in a 20 mm thick plate.

Here again, no defects were present on the preform thereby produced.

### Example 4

Example 4 was carried out with the same stacking as for examples 1 and 2, but with a displaced positioning of the stack, with respect to the top of the protrusion which had a different shape. The top of the protrusion formed an angle of 90°. In this case, a 300 mm by 180 mm plate was positioned so that the top of the protrusion forming a line divided the plate into two parallel strips: one 120 mm wide and the other 60 mm wide. The implementation of the simple diaphragm process of the prior art, resulted in a displaced preform, with the stack having moved 47 mm, compared to its initial position, but with no defects. The use of the dual-diaphragm process according to comparative example 1b or 1c made possible adequate positioning and thereby avoided a displacement. However, this process resulted in the presence of defects.

The implementation of the process as described in Example 2 resulted in both an absence of displacement and an absence of defects.

1-22. (canceled)

23. A device for molding and curing a stack of multiple layers of composite material, said composite material comprising fibrous reinforcing material and polymeric resin, said device comprising:
(a) a sealable chamber for inserting said stack of multiple layers of composite material, said chamber including at least one fixed element on the bottom surface thereof to impart a non-planar configuration to the stack of multiple layers of composite material as it is molded and cured inside said chamber;
(b) a first air-tight polymeric membrane disposed inside said sealable chamber above said fixed element, thereby defining a first volume of air between the bottom of said chamber and the underside of said polymeric membrane, said first volume of air being connected to the exterior of said chamber by a passage through which air can be extracted or introduced, whereby the air pressure inside said first volume of air can be increased or decreased; and
(c) a second air-tight polymeric membrane disposed above the first membrane, inside said chamber, thereby defining a second volume of air between the bottom of said second membrane and the upper surface of said first membrane, said second volume of air being connected to the exterior of said chamber by a passage through which air can be extracted or introduced, whereby the air pressure inside said second volume of air can be increased or decreased, said second volume of air being suitable to position said stack of multiple layers of composite material, whereby, through manipulation of the air pressures within said first and second volumes of air, and introducing heat to the stack of multiple layers of composite material, said stack of multiple layers of composite material can be molded and cured.

24. A method of molding and curing a stack of multiple layers of composite material into a cured article, said composite material comprising fibrous reinforcing material and polymeric resin, said method utilizing a device comprising:
(a) a sealable chamber for inserting said stack of multiple layers of composite material, said chamber including at least one fixed element on the bottom surface thereof to impart a non-planar configuration to the stack of multiple layers of composite material as it is molded and cured inside said chamber;
(b) a first air-tight polymeric membrane disposed inside said sealable chamber above said fixed element, thereby defining a first volume of air between the bottom of said chamber and the underside of said polymeric membrane, said first volume of air being connected to the exterior of said chamber by a passage through which air can be extracted or introduced, whereby the air pressure inside said first volume of air can be increased or decreased; and
(c) a second air-tight polymeric membrane disposed above the first membrane, inside said chamber, thereby defining a second volume of air between the bottom of said second membrane and the upper surface of said first membrane, said second volume of air being connected to the exterior of said chamber by a passage through which air can be extracted or introduced, whereby the air pressure inside said second volume of air can be increased or decreased, said second volume of air being suitable to position said stack of multiple layers of composite material, whereby, through manipulation of the air pressures within said first and second volumes of air, and introducing heat to the stack of multiple layers of composite material, said stack of multiple layers of composite material can be molded and cured; said method comprising the steps of:
(i) assembling a stack of multiple layers of composite material and inserting said stack into the second volume of air within said chamber;
(ii) withdrawing air from the second volume of air to reduce its volume and bring the first and second membranes into contact with said stack of multiple layers of composite material;
(iii) withdrawing air from the first volume of air to reduce its volume, to bring the portion of the first polymeric membrane directly underlying said stack of multiple layers of composite material into contact with the fixed element;
(iv) increasing the volume of air within the second volume of air to exert downward pressure on the stack of multiple layers of composite material, whereby the shape of said stack can be changed to confirm to the configuration of the fixed element on the bottom surface of the chamber;
(v) exerting heat on said stack of multiple layers of composite material; whereby a cured, shaped article is formed.

25. The method of claim 24, wherein the decrease in volume of said second volume of air in step (iii) is approximately equal to the increase in volume of the second volume of air in step (iv).
